(19) United States
(12) Patent Application Publication
(10) Pub. No.: US 2012/0099574 A1
(43) Pub. Date: Apr. 26, 2012

(54) COMMUNICATION DEVICE, COMPUTER READABLE MEDIUM AND RELAY METHOD USING SAME

(75) Inventor: Yoshiteru TAMURA, Nagoya-shi (JP)

(73) Assignee: Buffalo Inc., Nagoya-shi (JP)

(21) Appl. No.: 13/280,005

(22) Filed: Oct. 24, 2011

(30) Foreign Application Priority Data
Oct. 25, 2010 (JP) 2010-238630

(51) Int. Cl. H04W 84/02; H04W 48/18

(52) U.S. Cl. 370/338

(57) ABSTRACT

A communication device including a wireless local area network (LAN) interface and a wired LAN interface with a plurality of wired ports. The communication device obtains a media access control (MAC) address of a terminal connected to a wired port to relay communication between the terminal and a wireless device via the wireless LAN interface and the wired LAN interface by establishing an independent connection between the terminal and the wireless device using this MAC address.

### CROSS-REFERENCE TO RELATED APPLICATION

This application claims the benefit of Japanese Patent Application No. 2010-238630 filed on Oct. 25, 2010, the entire disclosure of which is incorporated herein by reference.

### BACKGROUND OF THE DISCLOSURE

1. Technical Field

The present disclosure relates to a communication device and a relay method using the same for relaying a communication packet, particularly to a communication device including a wireless LAN (Local Area Network) interface and a wired LAN interface having a plurality of ports, and a relay method for allowing the communication device to relay a communication packet.

2. Description of the Related Art

As a station which is a non-access point client (hereinafter, simply referred to as “station”), there has been known so-called Ethernet converter (Ethernet is a registered trademark). The Ethernet converter includes a station interface and a wired LAN interface, and performs a relay operation for relaying a communication packet through a format conversion based on the communication standards of both the interfaces. A wired device (electronic device), such as a terminal or a digital appliance each having a wired LAN port, may be connected to a wired LAN port of the Ethernet converter via a LAN cable, thus enabling the wired device to communicate with another wireless device via the Ethernet converter.

Such Ethernet converter includes one known type that is provided with a plurality of wired LAN ports, as disclosed in e.g., Japanese unexamined patent application publication No. 2010-50520. When the Ethernet converter provided with a plurality of wired LAN ports receives a communication packet from any wired device connected to the wired LAN port, the Ethernet converter then converts a format thereof and then transfers the same to any other wireless device. At this moment, the Ethernet converter adds its own MAC (Media Access Control) address to the communication packet transferred to the wireless device as a sender address. On the other hand, when the Ethernet converter receives a communication packet from any other wireless device, the Ethernet converter then sends the communication packet to a destination wired device based on the processing in an upper layer higher than the data link layer of an OSI (Open Systems Interconnection) reference model. For example, if TCP/IP (Transmission Control Protocol/Internet Protocol) is used as a communications protocol, then the Ethernet converter matches an address table in which the MAC address of the wired device connected to the Ethernet converter is associated with an IP address, against a destination IP address contained in the received communication packet and thus identifies the destination wired device. Then, the Ethernet converter converts the destination MAC address contained in the received communication packet into the MAC address of the wired device thus identified, to thereby transfer the received communication packet to the wired device. Such conversion process has been required when using NetBEUI (NetBIOS Extended User Interface) and Apple Talk (Apple Talk is a registered trademark) as well. Thus, the process of the conventional Ethernet converter inherently depends on the protocols, so that the communication between the wireless LAN interface and the wired LAN interface cannot be relayed transparently.

### SUMMARY

It is, therefore, an object of the present disclosure to provide a communication device including a wireless LAN interface and a wired LAN interface having a plurality of ports which enables the communication between the wireless LAN interface and the wired LAN interface to be relayed transparently. It is another object of the present disclosure to provide a relay method for allowing the communication device to relay a communication packet which enables the communication between the wireless LAN interface and the wired LAN interface to be relayed transparently.

According to a first exemplary embodiment, the disclosure is directed to a communication device comprising:

a wireless local area network (LAN) interface that communicates with a wireless device other than the communication device;

a wired LAN interface including a plurality of ports; and

a processor that relays communication between the wireless device and an electronic device connected to one of the plurality of ports via the wireless LAN interface and the wired LAN interface, wherein

the processor obtains a media access control (MAC) address of the electronic device, and relays the communication between the electronic device and the wireless device by establishing an independent connection between the electronic device and the wireless device using the obtained MAC address.

Therefore, since the communication device can relay the communication packet only based on the MAC address of the terminal, the communication device does not need to perform the processing based on the upper layer higher than the data link layer of the OSI reference model at the time of relaying the communication packet. That is, the communication between the wireless LAN interface and the wired LAN interface can be relayed transparently.

The address obtaining unit may be configured to obtain, from a communication packet received from the electronic device, the MAC address of the electronic device included in the received communication packet.

The communication device may further release the connection established between the electronic device and the wireless device when the communication between the electronic device and the wireless device has not been performed for a predetermined period of time.

Moreover, the relay unit may communicate with the wireless device under communication conditions varying between the independent connections.

According to another exemplary embodiment, the disclosure is directed to a relay method performed by a communication device including a wireless local area network (LAN) interface that communicates with a wireless device other than the communication device and a wired LAN interface including a plurality of ports, the relay method comprising:

obtaining a media access control (MAC) address of an electronic device connected to one of the plurality of ports; and

relaying communication between the electronic device and the wireless device by establishing an independent connection between the electronic device and the wireless device using the obtained MAC address.

According to another exemplary embodiment, the disclosure is directed to a non-transitory computer-readable medium including computer program instructions, which when executed by a communication device including a wireless local area network (LAN) interface that communicates with a wireless device other than the communication device and a wired LAN interface including a plurality of ports, causes the communication device to perform a method comprising:

obtaining a media access control (MAC) address of an electronic device connected to one of the plurality of ports; and

relaying communication between the electronic device and the wireless device by establishing an independent connection between the electronic device and the wireless device using the obtained MAC address

### BRIEF DESCRIPTION OF THE DRAWINGS

These objects and other objects and advantages of the present disclosure will become more apparent upon reading of the following detailed description and the accompanying drawings in which:

FIG. 1 is an explanatory drawing illustrating an Ethernet converter according to the embodiment of the present disclosure.

FIG. 2 is an explanatory drawing illustrating a schematic configuration of the Ethernet converter according to the embodiment of the present disclosure.

FIG. 3 is a flow chart illustrating a processing flow of a communication packet transfer (the transfer from a wired LAN interface to a wireless LAN interface) in the Ethernet converter according to the embodiment of the present disclosure.

FIG. 4 is an explanatory drawing illustrating a specific example of an address administration table.

FIG. 5 is a flow chart illustrating a processing flow of a communication packet transfer (a transfer from a wireless LAN interface to a wired LAN interface) in the Ethernet converter according to the embodiment of the present disclosure.

FIG. 6 is an explanatory drawing illustrating a specific example of a communication flow realized by the communication packet transfer processing of the Ethernet converter according to the embodiment of the present disclosure.

FIG. 7 is an explanatory drawing illustrating a specific example of a communication flow when an Ethernet converter according to a comparative example is used.

### DETAILED DESCRIPTION

Next is a description of an embodiment with reference to accompanying drawings.

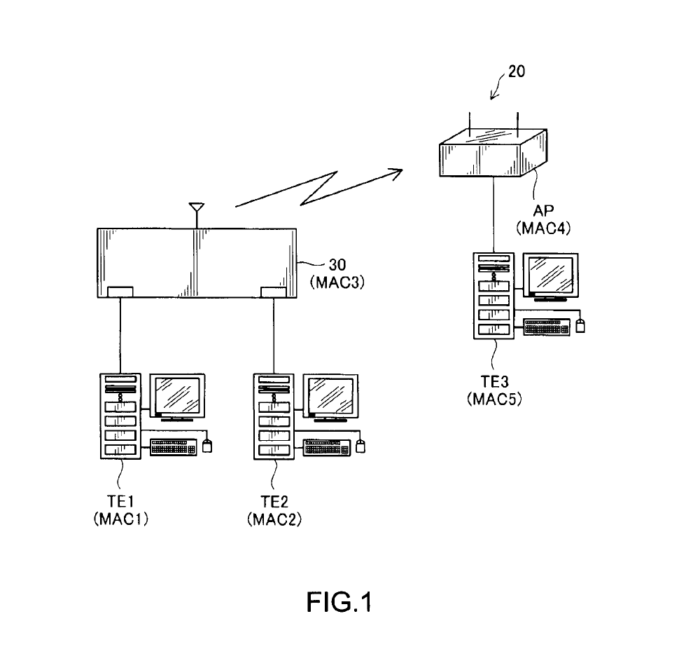

FIG. 1 shows an Ethernet converter 30 according to an embodiment of a communication device according to the present disclosure. FIG. 1 shows the configuration of a home network 20 which is built at home using the Ethernet converter 30. As shown in the drawing the home network 20 comprises the Ethernet converter 30, an access point AP which is a station serving as an access point (hereinafter, referred to as “access point”), and terminals TE1 to TE3.

The Ethernet converter 30 of the present embodiment has a function as a station (wireless terminal), and a bridge function to connect a wired LAN and a wireless LAN. The Ethernet converter 30 includes two wired LAN ports, and the terminals (electronic devices) TE1 and TE2 are connected to the wired LAN ports via the LAN cables, respectively. The terminals TE1 and TE2 are general-purpose personal computers having the wired LAN port. A MAC address “MAC1” is assigned to the terminal TE1, a MAC address “MAC2” is assigned to the terminal TE2 and a MAC address “MAC3” of a wireless LAN interface is assigned to the Ethernet converter 30.

This Ethernet converter 30 constructs the wireless LAN with the access point AP. The access point AP has the access point function to relay the communication between stations, and the bridge function to connect the wired LAN and the wireless LAN. In addition, the access point AP may have a router function and be configured in such a manner as to be capable of connecting to an external network. The access point AP has a wired LAN port, and the terminal TE3 is connected to the wired LAN port via the LAN cable. The terminal TE3 is a general-purpose personal computer as with the terminals TE1 and TE2. A MAC address “MAC4” is assigned to the access point AP and a MAC address “MAC5” is assigned to the terminal TE3.

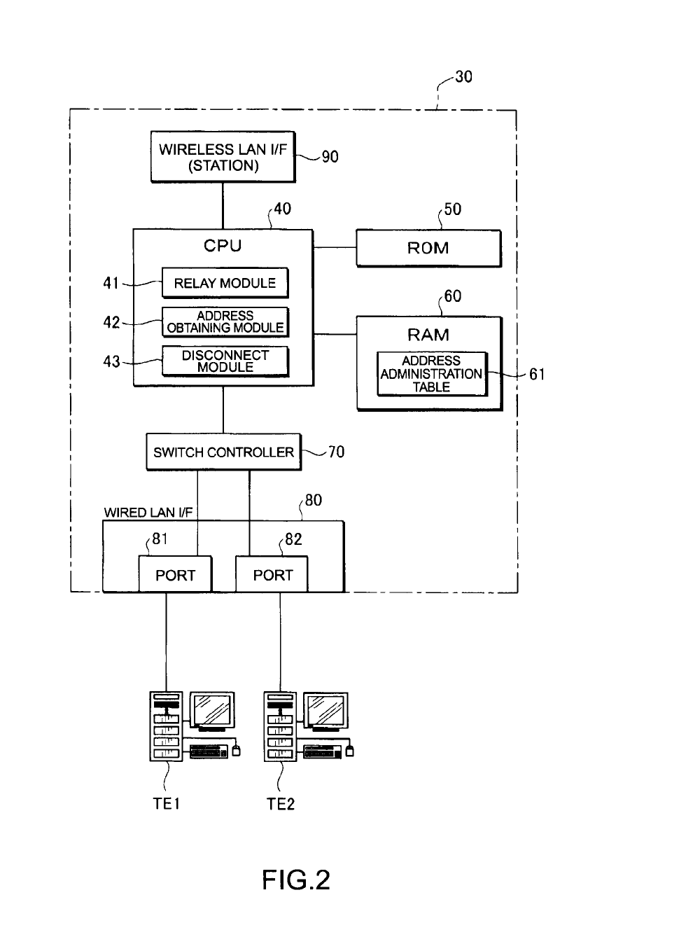

FIG. 2 is a schematic configuration of the Ethernet converter 30 of the embodiment. As shown in the drawing, the Ethernet converter 30 comprises a CPU (Central Processing Unit) 40, a ROM (Read Only Memory) 50, a RAM (Random Access Memory) 60, a controller 70, a wired LAN interface 80, and a wireless LAN interface 90, and they are connected each other by buses not shown.

The controller 70 is a switch controller which has a switching function, and takes out the MAC frame from the received communication packet, and sends the thus received communication packet to a port corresponding to a destination MAC address with reference to a MAC address table. Note that, in the present disclosure, data transfer unit for communication is called “communication packets” irrespective of any relation with the layer of an OSI reference model.

The wired LAN interface 80 is an interface for connecting to a wired LAN. In the present embodiment, the wired LAN interface 80 is based on IEEE (The Institute of Electrical and Electronics Engineers) 802.3 standards. The wired LAN interface 80 has two wired LAN ports 81, 82. The terminals TE1 and TE2 are connected to these wired LAN ports 81 and 82, respectively. Alternatively, the number of the wired LAN ports of the wired LAN interface 80 may be three or more.

The wireless LAN interface 90 is an interface serving as the station for connecting to a wireless LAN. In the present embodiment, the wireless LAN interface 90 is based on the IEEE 802.11 standards.

The CPU 40 extracts and executes, in RAM 60, programs such as a firmware memorized in ROM 50 to thereby control the general operations of the Ethernet converter 30. Moreover, the CPU 40 also functions as a relay module 41, an address obtaining module 42 and a disconnection module 43 by executing the programs. The relay module 41 relays the communications between the terminals TE1, TE2 and the access point AP, via the wired LAN interface 80 and the wireless LAN interface 90. That is, the relay module 41 controls the relay operation to transfer the communication packets, received from the access point AP via the wireless LAN interface 90, to the terminals TE1 and TE2 according to the destination addresses, via the wireless LAN interface 90, and then to transfer the communication packets, received from the terminal TE1 and TE2 via the wired LAN interface 80, to the access point AP via the wireless LAN interface 90. The address obtaining module 42 gets the MAC addresses of terminals TE1 and TE2 connected to the wired LAN interface 80, and registers them on the address administration table 61. The disconnection module 43 releases the connection established between the Ethernet converter 30 and the access point AP at predetermined timing. These functions will be described in more detail later. A region for memorizing the address administration table 61 is allocated in the RAM 60. The contents of the address administration table 61 will be mentioned later.

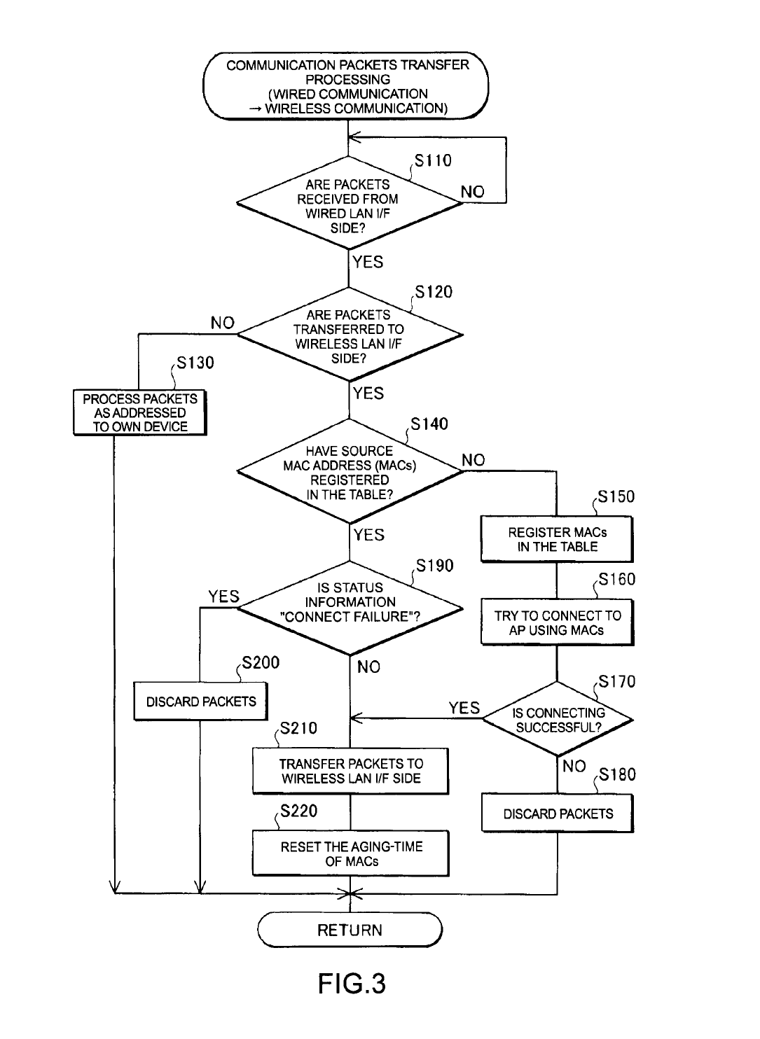

The communication packets transfer processing in the Ethernet converter 30 according to the present embodiment is explained below. The communication packets transfer processing is the processing in which the Ethernet converter 30 relays the communication between the terminals TE1, TE2 and the access point AP via the wired LAN interface 80 and the wireless LAN interface 90. The flow of communication packets transfer processing is shown in FIG. 3. The processing illustrated in FIG. 3 is the one performed in the case that the Ethernet converter 30 transfers the communication packets received from the wired LAN interface 80 side to the wireless LAN interface 90 side. Unless otherwise noted, the CPU 40 of the Ethernet converter 30 performs this processing as the processing of the relay module 41. In the present embodiment, the communication packets transfer processing shown in FIG. 3 is started after supplying power to the Ethernet converter 30, and repeatedly executed.

When the communication packets transfer processing is started as shown in FIG. 3, first, the CPU 40 of the Ethernet converter 30 stands by for the reception of the communication packets from the wired LAN interface 80 side, i.e., the terminals TE1 and TE2 (Step S110). Then, when the communication packets are received from the wired LAN interface 80 (Step S110: YES), the CPU 40 judges whether the communication packets should be transferred to the wireless LAN interface 90 side with reference to the destination MAC address in the received communication packets (Step S120).

If the packets should not be transferred to the wireless LAN interface 90 side as a result of the judgment (Step S120: NO), i.e., if the MAC address in the received communication packets is the MAC3 or its own MAC address, the CPU 40 hands over the communication packets to an upper layer, and processes the packets as the communication packets addressed to the device itself (Step S130). For example, if the received communication packets require a WEB data for displaying a setup screen of the Ethernet converter 30 by a WEB browser, the CPU 40 responds to the request for the WEB data by a WEB server function.

In contrast, if the communication packets should be transferred to the wireless LAN interface 90 side as a result of the judgment (Step S120: YES), i.e., if the MAC address in the received communication packets is a MAC address (including a broadcast address) other than the MAC3 or its own MAC address, the CPU 40 further judges whether a sender MAC address (hereinafter, also referred to as “MACs”) contained in the received communication packets has been registered in the address administration table 61 or not (Step S140).

Here, the address administration table 61 is explained. Although the following will be described in more detail later, the Ethernet converter 30 of the present embodiment establishes a logical and independent connection at each of the Ethernet converter itself and the terminals TE1, TE2 connected to the wired LAN ports 81, 82 of the wired LAN interface 80, with the access point AP, using each of the MAC addresses MAC1 to MAC3. That is, the Ethernet converter 30 of the present embodiment performs communication with the access point AP using the connections in the data flows which are multiplexed corresponding to the number of the terminals connected to the Ethernet converter 30. The address administration table 61 is a memory region which registers and manages each of the MAC addresses used for multiplexing the connection. This address administration table 61 is used also for connection management in the present embodiment.

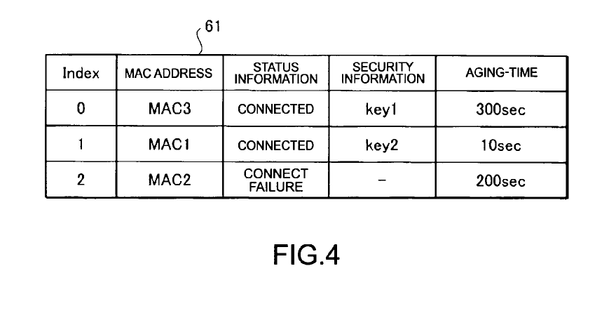

One specific example of the address administration table 61 is shown in FIG. 4. In this example, MAC address information, status information, security information, and an aging-time are associated with each other and stored in the address administration table 61. The MAC address information is information which represents each of the MAC addresses used for multiplexing the connection. In the example illustrated, MAC3 which is assigned to the MAC address of the Ethernet converter 30, MAC1 and MAC2 each of which is assigned to the MAC addresses of terminals TE1 and TE2, respectively, are stored as the MAC address information. The MAC3 is registered in the address administration table 61 in advance to be distinguished as its own MAC address. MAC1 and MAC2 are registered in the address administration table 61 by Step S150 that is mentioned later.

The status information shows the status of connection using each MAC address registered as the MAC address information. The status information includes a status of “connected” and a status of “connect failure” at least. The status of “connected” shows that the connection to the access point AP has been established. The status of “connect failure” shows that the Ethernet converter 30 tried to establish the connection to the access point AP, but it was resulted in failure. In the example illustrated, the status information corresponding to MAC3 and MAC1 are the status of “connected”, and the status information corresponding to MAC2 is the status of “connect failure”. Alternatively, the status information may also include other pieces of information about the status such as “now connecting”, “authenticated”, “now certificating authenticating”, and “connection was refused”. The status information is updated by CPU 40 whenever the status of the connection changes.

The security information represents security information used for communication using each connection. In the example illustrated, encryption keys key1 and key2 used for encrypted communication with the access point AP are stored, respectively while they are associated with MAC3 and MAC1. Since the connection is not established for MAC2, the encryption key has not been generated yet. In the present embodiment, WEP (Wired Equivalent Privacy) mode is adopted as the encryption method of encrypted communication, and the encryption keys key1 and key2 are key mapping keys generated uniquely for every connection, i.e., for each of the Ethernet converter 30 itself and the terminal TE1. If the connection is also established for MAC2, the encryption key is generated uniquely to be associated with MAC2 and stored. In short, the Ethernet converter 30 is configured in such a manner as to be capable of using different encryption keys among two or more connections multiplexed. The CPU 40 generates the encryption keys key1 and key2 through an authentication process for the access point AP, and registers them into the address administration table 61. In the meantime, it is not always necessary to manage the security information that have different contents for every connection.

An aging-time is a time to hold MAC address information on the address administration table 61. If a certain MAC address is registered in the address administration table 61, the aging-time therefor is set to the preset initial-setting time (in the present embodiment, 300 seconds). Then, the aging-time is subjected to countdown based on the passage of time, and if this countdown reaches 0, the MAC address and other information associated therewith is deleted from the address administration table 61. Since the MAC address of a device having a low possibility of communication is not memorized continuously in such a system, the limited memory capacity of the RAM 60 is effectively utilizable. In the present embodiment, if a certain MAC address is deleted from the address administration table 61, the CPU 40 sends disassociation request to the access point AP, and then releases the connection established using the MAC address, as the processing by the disconnection module 43. In the meantime, if the communication is performed between the device having a registered MAC address and the access point AP, the aging-time corresponding to the MAC address of the device that performed the communication is refreshed to be reset to the original initial-setting time. Note that this aging-time setting is not essential for the disclosure.

Back to the communication packets transfer processing, if the sender MAC address (MACs) in the received communication packets is not registered in the address administration table 61 (Step S140: NO), it means that the connection to the access point AP using the MACs is not established yet. Then, the CPU 40 gets a MACs from the received communication packets and registers it into the address administration table 61, as the processing by the address obtaining module 42 (Step S150).

If the MACs is registered, the CPU 40 tries to establish the connection with the access point AP using the MACs (Step S160). If establishment of the connection has failed (Step S170: NO), the CPU 40 discards the received communication packets (Step S180). At this time, the status information corresponding to the MACs registered into the address administration table 61 by the above-mentioned step S150 is updated to “connection failure.”

In contrast, if the Ethernet Converter 30 succeeds in establishment of the connection (Step S170: YES), the CPU 40 updates the status information corresponding to the MACs registered in the address administration table 61 to “connected” through the above-mentioned step S150, and transfers the received communication packets to the wireless LAN interface 90 side (Step S210). These communication packets are sent to the access point AP using the connection established by the above-mentioned step S160 using the MACs. If the communication packets are transferred, the CPU 40 refreshes the aging-time corresponding to MACs managed by the address administration table 61 (Step S220), and return the processing back to the initial processing.

At the same time, if the transferred sender MAC address (MACs) in the received communication packets has been registered in the address administration table 61 (Step S140: YES), the connection with the access point AP using the MACs might have been established. Therefore, the CPU 40 judges whether or not the status information corresponding to the MACs indicates the status of “connection failure” with reference to the address administration table 61 (Step S190). As a result, if the status information indicates the status of “connect failure” (Step S190: YES), the CPU 40 discards the received communication packets (Step S200).

0036

Conversely, if the status information does not indicate “connect failure” (Step S190: NO), i.e., if it indicates the status of “connected”, the received communication packets are transferred to the wireless LAN interface 90 side, and the communication packets are transferred to the access point AP using the connection established using MACs (Step S210). Then, the CPU 40 refreshes the aging-time corresponding to MACs managed on the address administration table 61 (Step S220), and returns to the initial processing, thus terminating the communication packets transfer processing in the case of transferring the communication packets received from the wired LAN interface 80 side to the wireless LAN interface 90 side.

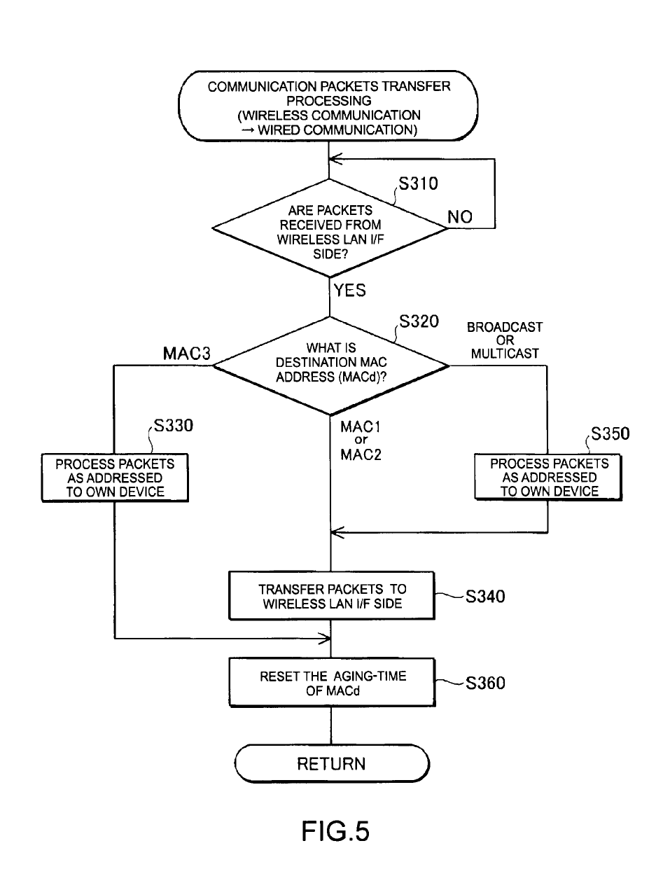

FIG. 5 shows the flow of the communication packets transfer processing in the case that the Ethernet converter 30 transfers the communication packets received from the wireless LAN interface 90 side to the wired LAN interface 80 side. Using any of MAC1 to MAC3, the communication packets transfer processing is started after the connection with the access point AP is established, and then is repeatedly executed. When the communication packets transfer processing is started as shown in FIG. 5, first, the CPU 40 of the Ethernet converter 30 stands by for the reception of the communication packets from the wireless LAN interface 90 side, i.e., the access point AP (Step S310).

And then, if the communication packets are received from the wireless LAN interface 90 side (Step S310: YES), the CPU 40 checks the destination MAC address (hereinafter, this is also referred to as “MACd”) contained in the received communication packets (Step 320). As a result, if MACd is MAC3, i.e., the MAC address of the Ethernet converter 30 (step S320: MAC3), the Ethernet converter 30 processes the received communication packets as the communication packets addressed to itself (Step S330). This processing is the same processing as in the above-mentioned step S130. Then, the CPU 40 refreshes the aging time corresponding to MACd (herein MAC3) managed on the address administration table 61 (Step S360), and returns the processing to the initial processing.

In contrast, if the destination MAC address (MACd) is MAC1 or MAC2, i.e., the MAC address of either the terminal TE1 or the terminal TE2 (step S320: MAC1 or MAC2), the CPU 40 transfers the received communication packets to the wired LAN interface 80 side (Step S340). In the meantime, if the destination MAC address (MACd) is a broadcast address or a multicast address (Step S320: broadcast or multicast), the CPU 40 processes the received communication packets as being addressed to itself (Step S350) and also transfers the received communication packets to the wired LAN interface 80 side (Step S340). The communication packet transferred to the wired LAN interface 80 side by Step S340 is transparently transferred by the controller 70 to either the terminal TE1 or TE2 which has the MAC address identical to MACd.

If the received communication packets are transferred to the wired LAN interface 80 side as mentioned above, the CPU 40 refreshes the aging-time corresponding to MACd managed on the address administration table 61 (Step S360), and returns the processing back to the initial processing. In the meantime, if MACd is a broadcast address, the aging-time corresponding to each of the MAC addresses registered in the address administration table 61 is refreshed, thus finishing the communication packets transfer processing in the case of transferring the communication packets received from the wireless LAN interface 90 side to the wired LAN interface 8 side.

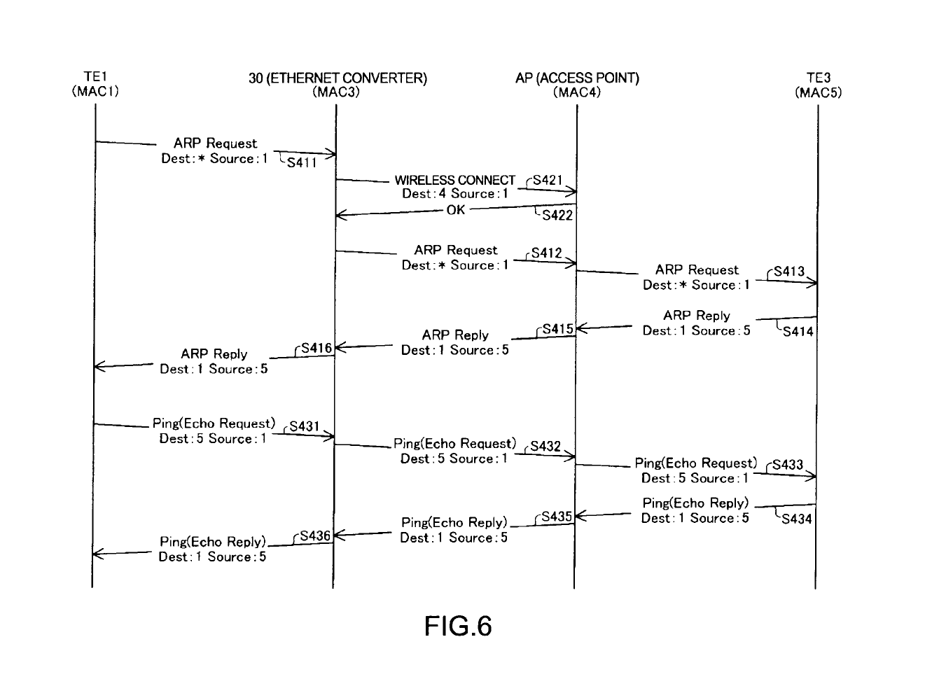

FIG. 6 shows a specific example of a communication flow realized by allowing the Ethernet converter 30 of the present embodiment to execute the foregoing communication packet transfer processing in the home network 20 shown in FIG. 1. FIG. 6 shows a communication flow in the case of checking the presence of the terminal TE3 from the terminal TE1 using ping (Packet INternet Groper). In FIG. 6, “Dest” denotes a destination MAC address and “Source” denotes a sender MAC address. Additionally, a symbol “*” shows a broadcast address. Note that in the present embodiment of the disclosure, an IP address of the terminal TE1 is pre-set in the terminal TE1 by a user's manual operation. However, when the access point AP has the function of DHCP (Dynamic Host Configuration Protocol) server, the terminal TE1 may receive an assignment of the IP address from the access point AP, by a DHCP process realized by means of the foregoing communication packet transfer processing. That is, when the terminal TE1 broadcasts a DHCP discovery packet, the Ethernet converter 30 establishes a connection to the access point AP using MAC1, which is a MAC address of the terminal TE1, by means of the foregoing communication packet transfer processing, and then the Ethernet converter 30 transfers the DHCP discovery packet to the access point AP. Then, the DHCP process is performed between the terminal TE1 and the access point AP using the connection, and thus, the terminal TE1 can receive assignment of the IP address from the access point AP.

When the terminal TE1 receives a command for sending the ping which designates the IP address of the terminal TE3, first, the terminal TE1 broadcasts an ARP (address Resolution Protocol) request to obtain a MAC address of the terminal TE3, as shown in FIG. 6 (Step S411). The sender MAC address of the ARP request is MAC1. When the Ethernet converter 30 receives this ARP request, the Ethernet converter 30 establishes a connection to the access point AP using the MAC1, in accordance with S160 described above (Step S421, 422). This processing is the one for interchanging a probe request, a probe response, an authentication, an association request, and an association response, as specified by IEEE802.11 standards.

The Ethernet converter 30 transfers the received ARP request to the access point AP, using the connection established by using MAC1, that is, by setting the sender MAC address as MAC1 (Step S412). This ARP request is received by the access point AP and is further transferred to the terminal TE3 (Step S413). The sender MAC address remains unchanged from MAC1.

On the other hand, when the terminal TE3 receives the ARP request, the terminal TE3 sends, as a response thereto, an ARP reply with MAC5 or its own MAC address as the sender MAC address, to the access point AP (Step S414). Since the terminal TE3 has received the ARP request with MAC1 set as the sender MAC address, the terminal TE3 sends the ARP reply with MAC1 set as a destination MAC address. The ARP reply sent by the terminal TE3 is received by the access point AP and is transferred to the Ethernet converter 30 (Step S415). The Ethernet converter 30 receives the ARP reply with the destination MAC address set as MAC1 and transfers the ARP reply transparently to the terminal TE1 having the MAC address of MAC1 (Step S416).

When the terminal TE1 receives the ARP reply to identify MAC5, i.e., the MAC address of terminal TE3 therefrom, then the terminal TE1 sends, to the Ethernet converter 30, an echo request of the ping with the sender MAC address set as MAC1 and the destination MAC address set as MAC5 (Step S431). In the same way as the ARP request described above, this echo request is transferred by the Ethernet converter 30 to the access point AP, using the connection established by using the MAC1 (Step S432), and is further transferred to the terminal TE3 (Step S433).

When the terminal TE3 receives the echo request with MAC5, i.e., its own MAC address, set as the destination MAC address, then the terminal TE3 sends, to the access point AP, an echo reply with the sender MAC address set as MAC5 and the destination MAC address set as the MAC1 (Step S434). In he same way as the ARP reply described above, this echo reply is transferred to the Ethernet converter 30 from the access point AP (Step S435), and is further transferred transparently to the terminal TE1 (Step S436). In this way, the terminal TE1 can check the presence of the terminal TE3.

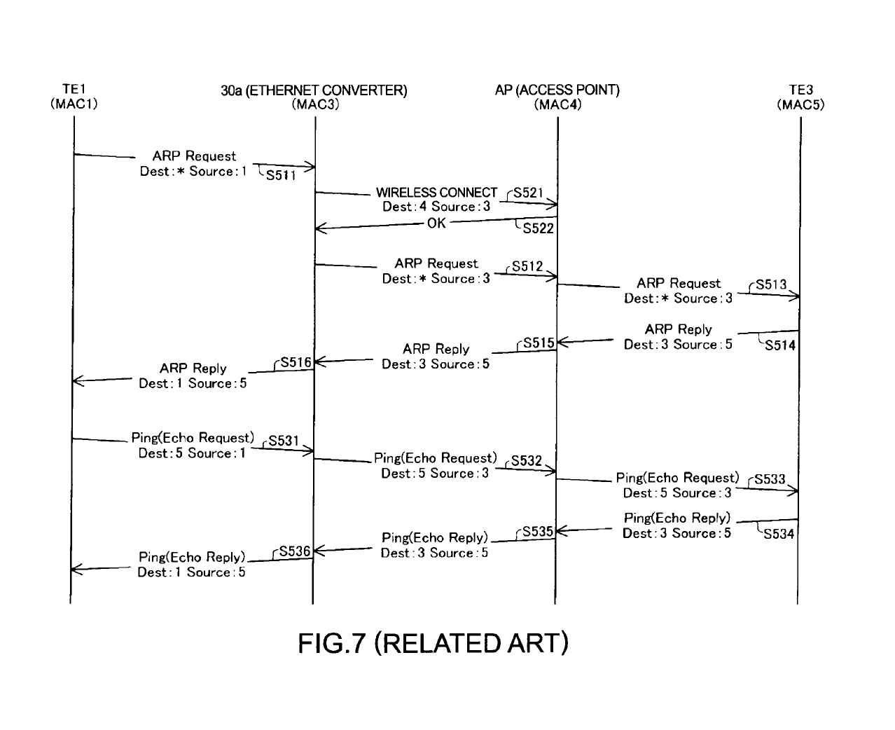

In order to more clearly understand the advantage of the Ethernet converter 30 according to the present embodiment of the disclosure, a description is first given for the communication flow in the case of using a conventional Ethernet converter 30a, and then, for advantages of the embodiment of the disclosure. FIG. 7 shows the communication flow in the case of using the Ethernet converter 30a as a conventional example. FIG. 7 shows the communication flow in the case of checking the presence of the terminal TE3 from the terminal TE1 using ping, as does FIG. 6. When the terminal TE1 receives a command for sending ping, then the terminal TE1 broadcasts an ARP request as shown in FIG. 7 (Step S511). A sender MAC address of the ARP request is MAC1.

When the Ethernet converter 30a receives this ARP request, the Ethernet converter 30a establishes a connection to the access point AP using MAC3 or an arbitrary MAC address set as the converter 30a's own MAC address or representation address (Step S521,522). However, this processing is omitted if the connection between the Ethernet converter 30a and the access point AP is established in advance. Then, the Ethernet converter 30a changes the sender MAC address of the received ARP request from MAC1 to MAC3 or its own MAC address and transfers it to the access point AP (Step S512). This ARP request is then received by the access point AP and is further transferred to the terminal TE3 (Step S513).

On the other hand, when the terminal TE3 receives the ARP request, the terminal TE3 sends an ARP reply with MAC5 or its own MAC address set as the sender MAC address, to the access point AP, as a response thereto (Step S514). Since the terminal TE3 has received the ARP request with MAC3 set as the sender MAC address, the terminal TE3 sends an ARP reply with MAC3 set as the destination MAC address. This ARP reply is received by the access point AP and is transferred to the Ethernet converter 30a (Step S515).

When the Ethernet converter 30a receives this ARP reply with the destination MAC address set as MAC3, the Ethernet converter 30a matches an ARP table having IP address and MAC address associated with each other, against a destination IP address in the ARP reply to identify an original destination of the ARP reply with MAC1. Then, the Ethernet converter 30a transfers the ARP reply with the destination MAC address changed from MAC3 to MAC1, to the terminal TE1 (Step S516). That is, this processing depends on the protocol such as IPv4 (Internet Protocol version 4) or IPv6 (Internet Protocol version 6).

Additionally, an echo request sent by the terminal TE1 is allowed to change the sender MAC address from MAC1 to MAC3 by the Ethernet converter 30a and is transferred to the terminal TE3 via the access point AP (Steps S531-S533). Then, the echo reply sent by the terminal TE3 is received by the Ethernet converter 30a via the access point AP, and then allowed to change the destination MAC address from MAC3 to MAC1 by the Ethernet converter 30a and is transferred to the terminal TE1 (Steps S534-S536).

On the other hand, the Ethernet converter 30 according to the present embodiment of the disclosure includes the wireless LAN interface 90 serving as the station and the wired LAN interface 80 with a plurality of the wired ports 81, 82. The Ethernet converter 30 gets the MAC address of the respective terminals TE1, TE2 connected to the wired ports 81, 82 to relay communications between the terminals TE1, TE2 and the access point AP by establishing an independent connection therebetween at each of the terminals TE1, TE2 using these MAC addresses. Therefore, the Ethernet converter 30 is allowed to relay the communication packet only based on these MAC addresses, and hence the Ethernet converter 30 does not need to refer to any upper layer higher than the data link layer of the OSI reference model at the time of relaying the communication packet. For example, there is no need to convert the destination MAC address based on the destination IP address. That is, the communication between the wireless LAN interface 90 and the wired LAN interface 80 can be relayed transparently.

Moreover, the Ethernet converter 30 according to the present embodiment of the disclosure gets the MAC1, the MAC2, which are the MAC addresses of the terminals TE1, TE2, from the communication packets received from the terminals TE1, TE2 connected to the wired LAN interface 80, and hence the configuration of the Ethernet converter 30 is simple. Furthermore, the Ethernet converter 30 gets the MAC addresses of the terminals TE1, TE2 just when the terminals TE1, TE2 send communication packets to the access point AP and there arises a need to establish the respective independent connection with the access point AP, thus enabling the processing to be made more efficient. Note that the Ethernet converter 30 may get the MAC address by any other suitable manner. For example, the CPU 40 may periodically have information on the MAC address table stored in the controller 70 to thereby get the MAC address.

Moreover, when the communication between either one of the terminals TE1 and TE2 and the access point AP has not been performed for a predetermined period of time, the Ethernet converter 30 according to the present embodiment of the present disclosure deletes the MAC address of the terminal TE1 or TE2 to which no communication has been performed, from the address administration table 61 to release the connection corresponding thereto. Thus, the Ethernet converter 30 can control the connections appropriately.

Still moreover, the Ethernet converter 30 according to the present embodiment of the disclosure can multiplex the relations of communication with the access point AP to perform different security setups between the connections. Therefore, flexible relay processing by the Ethernet converter 30 can be realized.

Still moreover, the Ethernet converter 30 of the present embodiment can achieve other remarkable effects than being capable of transparently transferring the communication packets, as explained hereinbelow. WOL (Wake-On-LAN) is known as a technique for remotely performing a turn-on operation of a network device through a network. In WOL, this remote control is performed using a communication packet called a magic packet. The magic packet contains, in an arbitrary domain of its body, a synchronization sequence “FF-FF-FF-FF-FF-FF”, and a subsequent data in which the MAC address of a device subjected to turn-on/off operation is repeated 16 times, and this magic packet is transferred by broadcasting. A device which has received the magic packet disregards it if the MAC address repeated 16 times is not its own MAC address, whereas, if it is its own MAC address, then the device starts and shifts from a power-saving state (for example, a sleep state where electric power is hardly consumed or a suspend state with a power supply being turned off, etc.) to a normal operating state.

Next is discussed a case of performing the turn-on operation of the terminals TE1 and TE2 from the terminal TE3 using WOL in the home network 20 shown in FIG. 1. If the conventional Ethernet converter 30a is used, instead of the Ethernet converter 30 of the present embodiment, in the home network 20, the Ethernet converter 30a changes the sender MAC address in the communication packet received from the terminal TE1 from MAC1 of the terminal TE1 to MAC3 of the Ethernet converter 30a and then transfers it to the terminal TE3 side, as mentioned above. As a result, the terminal TE3 cannot recognize MAC1 as the MAC address of the terminal TE1. Therefore, the terminal TE3 cannot send the magic packet containing the MAC1 of the terminal TE1 that is a target of turn-on/off operation. Even if the terminal TE3 recognizes the MAC address of the terminal TE1 as MAC3, and sends the magic packet containing the data comprising 16-time-repeated MAC3 to the IP address of the terminal TE1 via the access point AP and the Ethernet converter 30a, the terminal TE1 that has received this magic packet only interprets the MAC address contained in the magic packet as being not its own address, and discards this packet. Therefore, in the case that the conventional Ethernet converter 30a is used, WOL cannot be realized suitably.

On the other hand, according to the home network 20 configured using the Ethernet converter 30 of the present embodiment, the Ethernet converter 30 transfers the communication packets to the terminal TE3 side without changing the sender MAC address contained in the communication packet received from the terminal TE1. Accordingly, the terminal TE3 can recognize MAC1 as the MAC address of the terminal TE1. As a result, if the terminal TE3 sends the magic packet containing the data in which the MAC1 of the terminal TE1 as a target of the turn-on/off operation is repeated 16 times, to the terminal TE1 via the access point AP and the Ethernet converter 30, then the terminal TE1 can interpret the received magic packet as the one addressed to itself, and thus it can perform the starting processing. Such advantageous effect can be obtained not only in the case that WOL is realized in the home network 20, but also in such a general case where a remote control is performed using a protocol configured in a manner capable of directing an electric device having a MAC address that has received communication packets to perform a predetermined operation, based on information on the MAC address in the body of the communication packets.

Next is a description of modified embodiments of the present embodiment of the disclosure. Although the present embodiment described above shows the configuration for performing the encrypted communication with the access point AP using the different encryption keys between the multiplexed connections, various different security setups may be employed between the connections. For example, different encryption mode may be set up between the connections. As examples of such encryption mode, TKIP (Temporal Key Integrity Protocol), AES (Advanced Encryption Standard), etc. may be employed except WEP described above. It goes without saying that not only the security setup but various other communication conditions may be set up in a manner varying between the connections. For example, a transfer rate, e.g., may be changed between the connections. Alternatively, at least one of the connections may be band-limited. Note that it is needless to say that the communication conditions may be identical between some of the connections.

Such communication conditions may be set up for each of the wired ports 81, 82 of the wired interface 80 using a setting screen obtained from the WEB browser of the terminal TE1 and the terminal TE2 using the WEB server function of the Ethernet converter 30, for example. In this way, the communication condition suitable for the characteristic of the devices connected to the wired ports 81, 82 can be set up. For example, when a television set is connected to the wired port 81 and a personal computer is connected to the wired port 82, a security level of the connection corresponding to the personal computer may be set up relatively highly because the communication performed by a personal computer often requires higher security than the communication by a television set. Alternatively, when a television set is connected to the wired port 81 and an audio device is connected to the wired port 82, transfer rate of connection corresponding to the television set may be set up relatively highly because video data are often transmitted to the television set.

When different communication setups are employed for each of the wired ports 81, 82 as described above, the CPU 40 may be configured so as to periodically have information in the MAC address table stored in the controller 70. This makes it possible to grasp correspondence relationships between the wired ports 81, 82 and the MAC addresses MAC1, MAC2 of the terminals TE1, TE2 connected to the wired ports 81, 82, enabling different communication setups for each of the wired ports 81, 82 to be set up suitably. Alternatively, if the Ethernet converter 30 is a device compatible with the tag VLAN (Virtual Local Area Network), the correspondence relationships between the wired ports 81, 82 and the MAC addresses MAC1, MAC2 of the terminals TE1, TE2 connected thereto can be grasped with reference to the tag information (VLAN number) and the MAC address which are included in the communication packets received, provided predetermined VLAN numbers are assigned to the wire ports 81, 82 serving as tag ports.

Alternatively, such communications condition varying for every connection may be configured so that the Ethernet converter 30 sets up them autonomously. For example, in the case that the Ethernet converter 30 and the terminals TE1 and TE2 support protocols which can grasp the function of a device on the network, such as UPnP (Universal Plug and Play), SLP (Service Location Protocol), etc., the function of the device connected to the wired LAN ports 81 and 82 may be grasped using these protocols, and the communication condition determined beforehand according to the function may be set up.

It should be noted that the network configurations of the home network 20 according to the above-mentioned embodiments are described by way of example only, and any suitable one may be employed as long as the Ethernet converter 30 constructs a network configuration connecting a wired LAN and a wireless LAN. For example, the access point AP may be configured in a manner capable of relaying the communication packets of a plurality of stations including the Ethernet converter 30 of the present embodiment. Alternatively, the Ethernet converter 30 may be configured in a manner capable of ad-hoc mode wireless-communication with other stations including another Ethernet converter 30 instead of the access point AP. Moreover, the terminals TE1-TE3 connected to the Ethernet converter 30 or the access point AP may be not only a personal computer, but also any other various electronic devices provided with a wired LAN port. Such electronic devices may include a peripheral equipment of a personal computer, a AV equipment, a telephone, various home electronics (for example, a television set, a blu-ray player, etc.).

It should be noted that the present disclosure is not limited to the present embodiments, and the various changes or modifications may be made without departing from the scope of the disclosure. For example, this disclosure can also be realized as a relay method of communication packets, a program, and a memory media recording the program other than the configurations of a communication device.

What is claimed is:

1. A communication device comprising:
a wireless local area network (LAN) interface that communicates with a wireless device other than the communication device;
a wired LAN interface including a plurality of ports; and
a processor that relays communication between the wireless device and an electronic device connected to one of the plurality of ports via the wireless LAN interface and the wired LAN interface, wherein
the processor obtains a media access control (MAC) address of the electronic device, and relays the communication between the electronic device and the wireless device by establishing an independent connection between the electronic device and the wireless device using the obtained MAC address.

2. The communication device according to claim 1, wherein the processor obtains the MAC address corresponding to the electronic device from a communication packet received from the electronic device.

3. The communication device according to claim 1, wherein the processor releases the connection between the electronic device and the wireless device when communication between the electronic device and the wireless device has not been performed for a predetermined period of time.

4. The communication device according to claim 1, wherein a plurality of electronic devices are each connected to a respective one of the plurality of ports, and the processor obtains respective MAC addresses of each of the electronic devices and relays communication between each of the electronic devices and the wireless device by establishing respective independent connections between each of the electronic devices and the wireless device using the obtained MAC address.

5. The communication device according to claim 4, wherein the processor controls communication with the wireless device under communication conditions that vary between each of the respective independent connections.

6. A communication device comprising:
a wireless local area network (LAN) interface that communicates with a wireless device other than the communication device;
a wired LAN interface including a plurality of ports;
a relay unit for relaying a communication between the wireless device and an electronic device connected to one of the plurality of ports via the wireless LAN interface and the wired LAN interface; and
an address obtaining unit for obtaining a media access control (MAC) address of the electronic device,
wherein the relay unit relays the communication between the electronic device and the wireless device by establishing an independent connection between the electronic device, using the obtained MAC address.

7. A relay method performed by a communication device including a wireless local area network (LAN) interface that communicates with a wireless device other than the communication device and a wired LAN interface including a plurality of ports, the relay method comprising:
obtaining a media access control (MAC) address of an electronic device connected to one of the plurality of ports; and
relaying communication between the electronic device and the wireless device by establishing an independent connection between the electronic device and the wireless device using the obtained MAC address.

8. A non-transitory computer-readable medium including computer program instructions, which when executed by a communication device including a wireless local area network (LAN) interface that communicates with a wireless device other than the communication device and a wired LAN interface including a plurality of ports, causes the communication device to perform a method comprising:
obtaining a media access control (MAC) address of an electronic device connected to one of the plurality of ports; and
relaying communication between the electronic device and the wireless device by establishing an independent connection between the electronic device and the wireless device using the obtained MAC address.
